(19) United States
(12) Patent Application Publication
(10) Pub. No.: US 2026/0170808 A1
(43) Pub. Date: Jun. 18, 2026

(54) EFFICIENT HOMOGRAPHY ESTIMATION FOR IMAGE ANALYSIS

(71) Applicant: Samsung Electronics Co., Ltd., Suwon-si (KR)

(72) Inventors: Mohammad Waqas ASGHAR, San Diego, CA (US); Oleg KHORUZHIY, San Diego, CA (US); Hoon JO, Hwaseong-si (KR); Ho June LEU, Hwaseong-si (KR); Sungho HA, Hwaseong-si (KR)

(21) Appl. No.: 19/248,457

(22) Filed: Jun. 24, 2025

Related U.S. Application Data
(60) Provisional application No. 63/734,021, filed on Dec. 13, 2024.

(51) Int. Cl. G06V 10/77; G06V 10/44; G06V 10/74; G06V 10/75; G06V 40/20

(52) U.S. Cl. CPC G06V 10/7715; G06V 10/443; G06V 10/761; G06V 10/759; G06V 40/23

(57) ABSTRACT

A system and a method are described herein for an efficient technique of estimating a homography. A feature extractor is configured to extract a first set of features from a first image and a second set of features from a second image. A feature matcher is configured to match the first set of features to the second set of features to generate matched pairs of features. A parameter estimator is configured to estimate parameters of a transformation that transforms the first set of features to the second set of features based on the matched pairs using an iterative procedure that generates a difference measure between a previous homography in a previous iteration and a current homography in a current iteration. The difference measure corresponds to a quadric surface that has a maximum value and the iterative procedure is terminated when the maximum value is less than a predetermined threshold.

### CROSS-REFERENCE TO RELATED APPLICATION

This application claims the priority benefit under 35 U.S.C. § 119(e) of U.S. Provisional Patent Application Ser. No. 63/734,021 filed on Dec. 13, 2024, the disclosure of which is incorporated by reference in its entirety as if fully set forth herein.

### TECHNICAL FIELD

The disclosure generally relates to image analysis. More particularly, the subject matter disclosed herein relates to homography estimation in image analysis.

### BACKGROUND

The present background section is intended to provide context only, and the disclosure of any concept in this section does not constitute an admission that said concept is prior art.

Homography estimation is a technique in image analysis that estimates the parameters of a transformation that describes the relationship between two images of an object obtained at two different viewpoints or two different time instants. There are several methods to estimate the homographic parameters including feature-based and learning-based methods. The feature-based methods employ matching features of the two images to infer the parameters.

The inference of the parameters may be obtained through several techniques including solutions of a set of equations, Taylor series expansion, binary and bipartite graph matching, keypoint and similarity correspondence, and high-accurate localized features. Some of these techniques use closed-form solutions or iterative procedures based on some specified criteria. Optimizations using pre-defined costs functions may also be performed. Techniques using iterative procedures often require a termination to stop the iteration. However, the termination condition is often ill specified, often involving formulating an error value between successive iterations and comparing the error with a predetermined threshold. The determination of the error value and the threshold value is often arbitrary, resulting in either early or late termination, and therefore leading to inaccurate results and/or wasted resources.

The above information disclosed in this Background section is only for enhancement of understanding of the background of the disclosure and therefore it may contain information that does not constitute prior art.

### SUMMARY

To overcome these issues, systems and methods are described herein for an efficient technique of estimating a homography. A feature extractor is configured to extract a first set of features from a first image and a second set of features from a second image. A feature matcher is configured to match the first set of features to the second set of features to generate matched pairs of features. A parameter estimator is configured to estimate parameters of homography or a transformation that transforms the first set of features to the second set of features based on the matched pairs using an iterative procedure that generates a difference measure between a previous homography in a previous iteration and a current homography in a current iteration. The difference measure corresponds to a quadric surface that has a maximum value and the iterative procedure is terminated when the maximum value is less than a predetermined threshold BRIEF DESCRIPTION OF THE DRAWINGS

In the following section, the aspects of the subject matter disclosed herein will be described with reference to exemplary embodiments illustrated in the figures, in which:

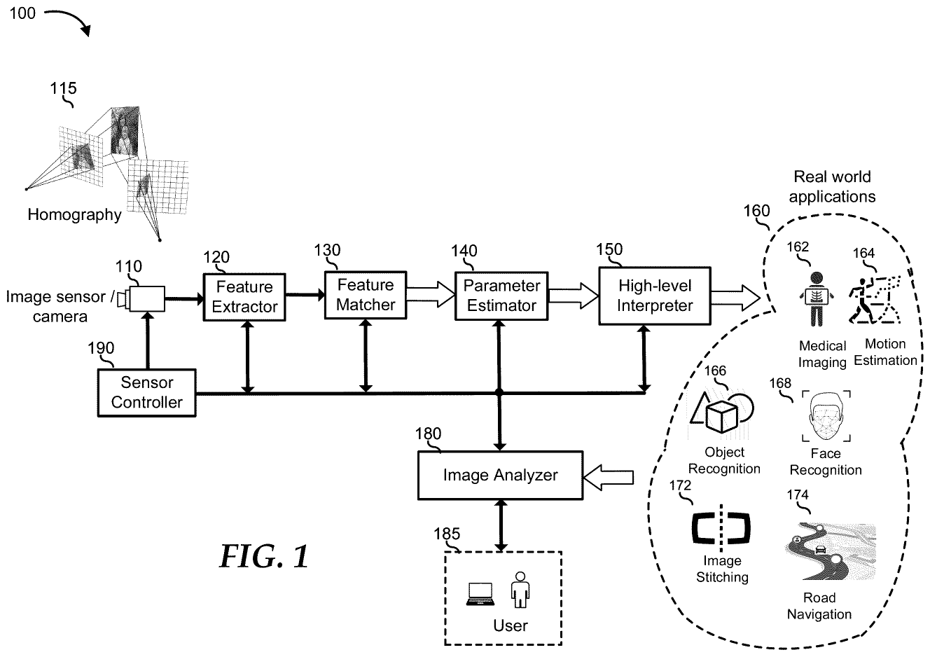

FIG. 1 is a block diagram illustrating a system according to an embodiment.

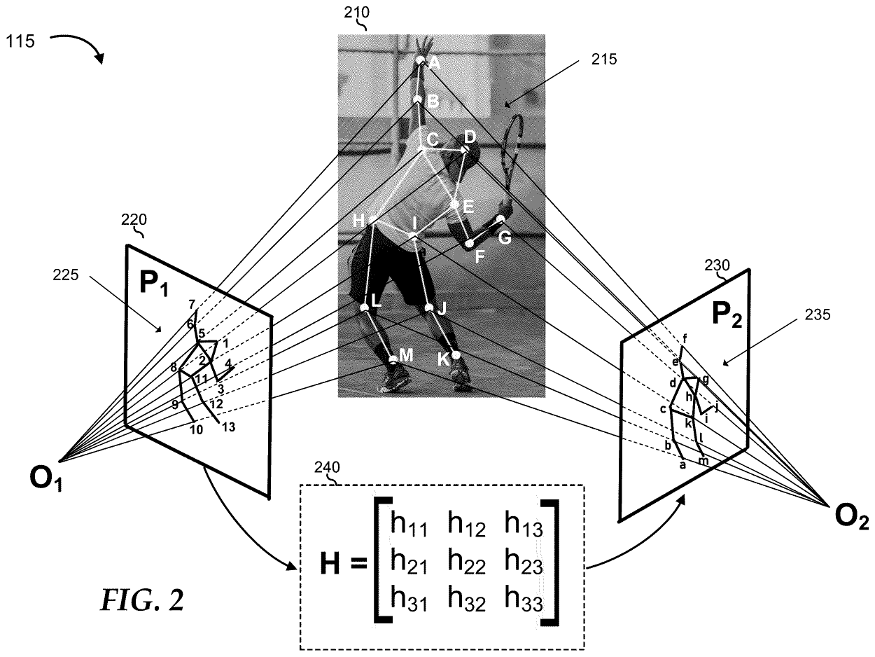

FIG. 2 is a diagram illustrating a homography of a tennis player in action according to an embodiment.

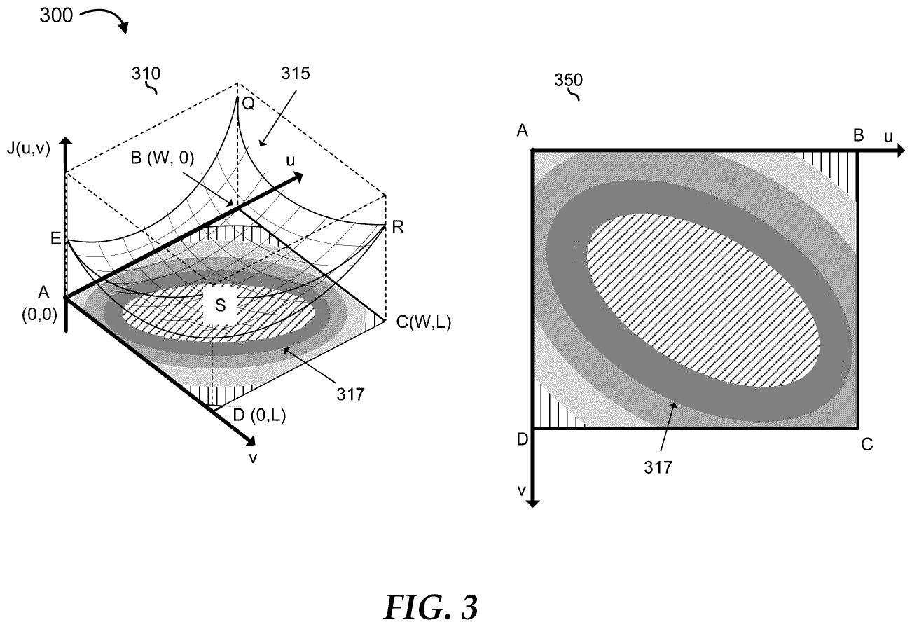

FIG. 3 is a diagram illustrating a quadric surface representing the difference measure between two consecutive iterations according to an embodiment.

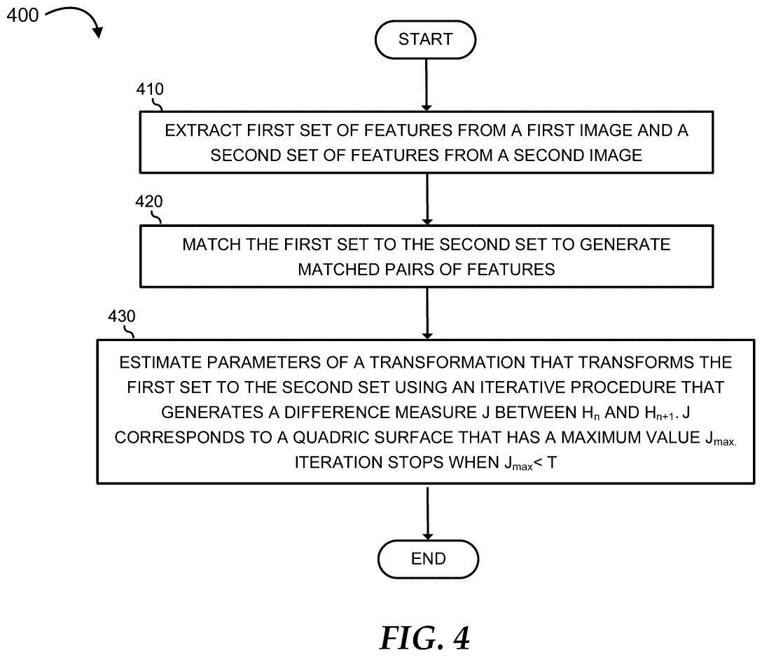

FIG. 4 is a flowchart illustrating a process of an efficient technique for homography estimation according to an embodiment.

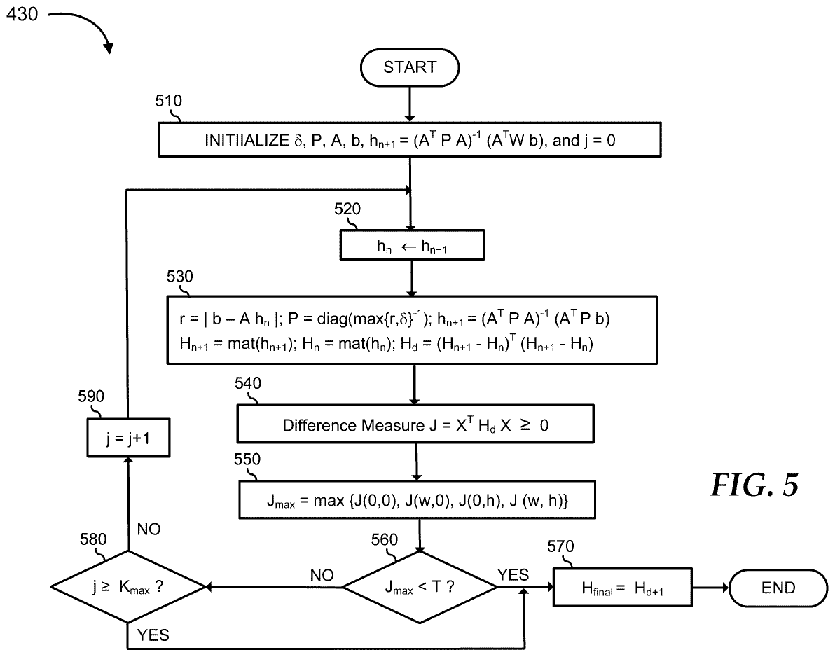

FIG. 5 is a flowchart illustrating a process for an iterative procedure for homography estimation according to an embodiment.

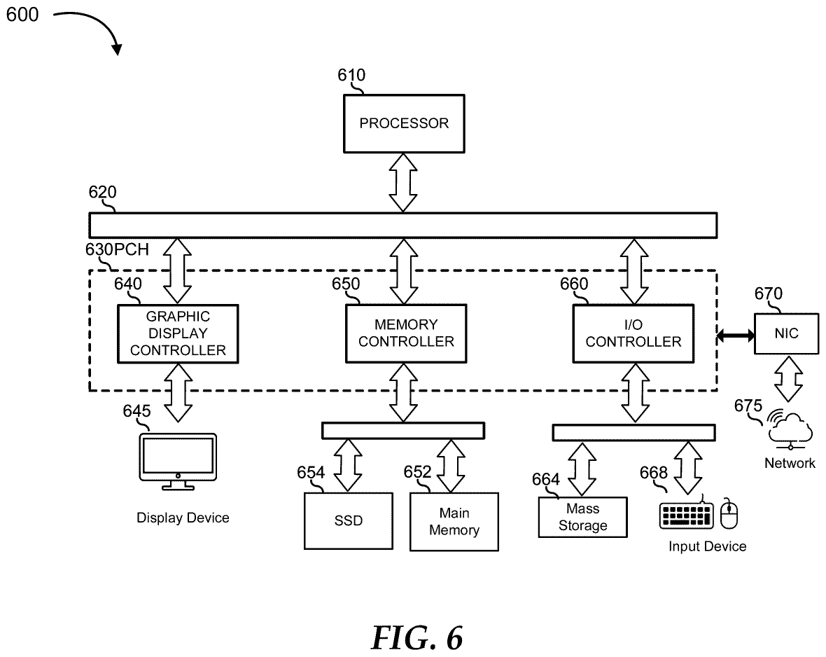

FIG. 6 is a diagram illustrating a processing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “homography” refers to a transformation or the matrix that represents the transformation between images. The homography matrix, typically having a dimension of 3×3, describes the geometric relationship between two views of an object on a planar surface. The matrix provides mapping points from one image to the corresponding points in the other image, assuming both images capture the same planar surface from different viewpoints.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a system 100 according to an embodiment. The system 100 is a system used for image analysis, machine vision, or image processing. It includes an image sensor or camera 110, a feature extractor 120, a feature matcher 130, a parameter estimator 140, a high-level interpreter 150, an image analyzer 180, and a sensor controller 190. The system 100 may include more or less than the above components. Each of the above components may be implemented by hardware, or software, or a combination of both.

The image sensor or camera 110 captures images of an object or a scene. The scene may be static or dynamic, including movements of objects. The object may be an inanimate object such as a building or a vehicle, or a living object such as a human being or an animal. The image sensor or camera 110 may include a single sensor or multiple sensors arranged at various viewpoints. The sensor or camera 110 may capture multiple images of the object or the scene in a multiple sensor configuration or single sensor configuration. For a single sensor configuration, the multiple images may come from consecutive images in a movie or a video. For a multiple sensor configuration, the multiple sensors may be located at various locations and aim at the scene or the object. An example of such configuration is stereo imaging where two sensors or cameras view a three-dimensional (3-D) scene from two distinct positions.

In a two-sensor or -camera configuration, one particular example is a homography 115. The homography 115 depicts a configuration in which two sensors or cameras captures two images of the same object and project them on the same planar surface. Homography has a number of applications including image rectification, image registration, or camera motion. In one embodiment, the imaging configuration for the system 100 is a homography. The two images of the same object or scenes are considered to be related through a transformation or homography that is characterized by a set of features in the images.

The feature extractor 120 extracts the features of the images captured by the image sensor or camera 110. The features of the images may be any features suitable to image matching or correspondence. In one embodiment, the features are image points on the object of interest. The object points may correspond to points that strongly characterize the object. Some examples are corner points or strong edges. When used in homography applications, two images are typically obtained. The feature extractor 120 is configured to extract a first set of features from a first image and a second set of features from a second image. These two sets will then be further processed.

The feature matcher 130 receives the two sets of features from the feature extractor 120 and determines a correspondence between these two sets. The correspondence is typically referred to as a matching operation. In other words, a point P₁ in the first image and a point P₂ in the second image are matched or correspond to each other when they are the image points of the same object point P of the object in the image. An example of a technique to perform image matching is the Random Sample Consensus (RANSAC). Given two sets of features from the feature extractor 120. The feature matcher 130 is configured to match the first set to the second set to generate matched pairs of features. The matched pairs will form the basis for estimation of the homography or transformation that transforms the feature points in the first image to the feature points in the second image. When the parameters of the transformation or the homography are known, the entire image may be transformed into the second image and image points on the entire image may then be registered or adjusted.

The parameter estimator 140 is configured to estimate parameters of a transformation, or homography, that transforms the first set to the second set based on the matched pairs. In one embodiment, the parameters are estimated based on the set of feature points in the two images. These parameters may be obtained by solving a set of linear equations using an iterative procedure. In one embodiment, the method employs the iterative re-weighted least squares (IRLS) algorithm. The IRLS algorithm is used for estimating regression coefficients. The estimation of regression coefficients is based on an optimization procedure because no closed-form solution exists. Accordingly, an iterative procedure is necessary to obtain the optimal result based on the least squares criteria. The algorithm computes weighted least squares estimates at each iteration step and updates the weights at each iteration. The iterative procedure obtains an estimate of the parameters at each iteration. The iterative procedure is stopped when a stopping condition is met. In one embodiment, this stopping condition is determined based on a difference measure between a previous homography in a previous iteration and a current homography in a current iteration. As will be shown later, unlike previous techniques that simply compare a difference between the previous homography and the current homography with a predetermined threshold, an embodiment determines a maximum value of a quadric surface of the difference measure. The maximum value corresponds to a largest value of four corners of intersections between the quadric surface and four boundary planes of a coordinate system. The iterative procedure is terminated when the maximum value is less than a predetermined threshold.

The high-level interpreter 150 performs high-level interpretation based on the results of the parameter estimator 140, namely the homography parameters. The homography parameters may then be applied to the images so that subsequent operations can be carried out. The exact operations depend on the specific application as one of real-world applications 160.

Examples of the real-world applications 160 include medical imaging 162, motion estimation 164, object recognition 166, face recognition 168, image stitching 172, and road navigation 174. Other applications may include motion analysis in athletes' techniques in sports such as tennis, football, basketball, etc. FIG. 2 provides an example of motion analysis of a tennis player. The contextual information regarding the specific environment may be employed to provide information for interpretation. For example, road conditions, relative positions of facial elements, structural relationships between internal organs, speed of movements, etc.

The image analyzer 180 is configured to analyze the images by controlling the various blocks in the system 100. It may include a programmable processor or circuit that executes a set of instructions or a program to perform specified tasks. FIG. 6 provides an example of such a processor. It may provide control parameters for the feature extractor 120 such as corner or edge threshold, the feature matcher 130 such as local regions or variances for region matching, the parameter estimator 140 such as initial values or threshold constants, and the high-level interpreter 150 such as contextual information on the real-world applications 160. In addition, the image analyzer 180 may also interact with a sensor controller 190 to control and/or monitor the image sensor or camera 110 such as shutter adjustment, pan and zoom control.

The image analyzer 180 may also interact with a user 185 via a user interface. The user 185 may select the operations, set the criteria, specify the operational conditions, and other parameters as part of the overall image analysis tasks.

FIG. 2 is a diagram illustrating a homography 115 of a tennis player in action according to an embodiment. The figure is mainly for illustrative purposes and may not describe the exact configuration. The homography 115 includes a scene 210, a first image plane 220, a second image plane 230, and a homography matrix 240. The image planes 220 and 230 may be considered coplanar so that homography may be employed. The homography 115 depicts an example of applying computer vision in pose estimation. The technique analyzes the movement of a tennis player by identifying and tracking key points, or joints, on the body. From the images of these key points, various aspects of the player's movement can be analyzed such as a player's swing including back swing, acceleration, and follow-through. The results of the analysis are useful for coaches or players to gain insight into the technique and identify areas for improvements.

The scene 210 shows a tennis player who appears to serve with the tennis racquet on his right hand. There are lighted markers placed on the player's body at key points or joints. These are the following 13 points: A, B, C, D, E, F, G, H, I, J, K, L, and M. These locations are selected based on their roles in body movements. By tracking these markers, a motion analysis can be performed. These points form a skeleton 215 which will be captured by cameras placed at viewpoints O₁ and O₂. The images of these markers are obtained on the image planes P₁ and P₂ of the sensors O₁ and O₂, respectively. For illustrative purposes, these markers are referred to as feature points. In practice, the feature extractor 120 in FIG. 1 does not have the benefit of having markers placed on the object or the scene to be analyzed. Instead, the feature extractor 120 automatically determines the interest points based on the image characteristics such as intensities, local variances, etc.

The skeleton 215 having the above 13 points is projected on the plane P1 of the image plane 220 in a skeleton 225 which has 13 feature points corresponding to the 13 points in the skeleton 215. This is the first set of feature points: 1, 2, 3, 4, 5, 6, 7, 8, 9, 10, 11, 12, and 13. Similarly, the plane P2 of the image plane 230 has a skeleton 235 including 13 corresponding feature points. This is the second set of feature points: a, b, c, d, e, f, g, h, I, j, k, l, and m. In practice, the number of feature points in the first image and the number of feature points in the second image may not be the same because the feature extractor 120 performs feature extraction without using a guided scheme with the markers and the detected features may be influenced by variations in light intensity and other image artifacts. There are ways to select the feature points in both images so that they have the same number of feature points. One example is to use local variances and select points that have similar local variances,

The homography 240 is a 3×3 matrix with components h₁₁, h₁₂, h₁₃, h₂₁, h₂₂, h₂₃, h₃₁, h₃₂, and h₃₃. The matrix H is in effect a transformation that converts the first set of feature points to the second set of feature points. Since the feature points are assumed to characterize the entire images, this matrix H may also transform the first image into the second image. Accordingly, once the elements h_{ij's} (i=1 to 3, j=1 to 3) of matrix H, the entire first image may be transformed into the second image. This may be used in various image processing tasks such as image stitching, augmented reality, and perspective correction.

Suppose two feature points A and B are two corresponding points defined by a homography matrix H in the first and second image planes. Assuming they are coplanar, their homogeneous coordinates are A(u, v, 1) and B(u′, v′, 1) where A and B are column vectors. In matrix notation, this may be expressed as:

$$\underline{B} = \underline{H} \underline{A} \qquad ( 1 )$$

$$Or : {( {u}^{′} , {v}^{′} , 1 )}^{T} = {\underline{H} ( u , v , 1 )}^{T} \qquad ( 2 )$$

where T is the transpose notation.

In practice, h₃₃ is equal to 1, and there are 8 unknowns h₁₁, h₁₂, h₁₃, h₂₁, h₂₂, h₂₃, h₃₁, and h₃₂. To solve for 8 unknowns, we need to have at least 8 equations. Accordingly, having only one feature pair is not enough. We need at least 4 feature pairs. In practice, there are many feature pairs in two corresponding images, which result in overdetermined equations. The method of least-squares is used to fit the solutions so that they have the least squared errors. Among several least-squares techniques, the iterative re-weighted least squares (IRLS) provides a reliable method to estimate the parameters h_{ij's} in the homography H.

The above derivation assumes the correspondence between the first set of features and the second set of features is known. In practice, this correspondence problem has to be solved to obtain the feature pairs. This is what the feature matcher 130 is configured to do. In FIG. 2, the feature points in the skeleton 215 provide the feature points in the skeleton 225 and 235 as follows:

For the first image plane 220:

A → 7
B → 6
C → 5
D → 1
E → 2
F → 3
G → 4
H → 8
I → 11
J → 12
K → 13
L → 9
M → 10

For the second image plane 230:

A → f
B → e
C → d
D → g
E → h
F → i
G → j
H → c
I → k
J → l
K → m
L → b
M → a

The feature corresponding pairs are:

| | | |
|---|---|---|
| 7 → f | 3 → i | 13 → m |
| 6 → e | 4 → j | 9 → b |
| 5 → d | 8 → c | 10 → a |
| 1 → g | 11 → k | |
| 2 → h | 12 → l | |

The above is to illustrate the corresponding point pairs. In practice, since the feature points of the original object are not known, the correspondence or feature matching is done using matching techniques such as RANSAC, correlation, graph matching, etc.

### Determining Termination Condition Using IRLS:

For brevity and clarity, the notation of matrix and vector will not be used when the context makes it clear that a variable is a matrix or a vector. The coordinates of the feature point pairs are used in the IRLS. These coordinates are used to create non-homogenous systems of equations of the form Ah=b where A is a constant matrix of size 2N×8, N being the number of feature points, h is an 8×1 vector containing the homography parameters and b is an 8×1 vector of constants. IRLS then iteratively solves Ah=b for h.

Given two homographies Hₙ₊₁ and Hₐ representing two consecutive homographies obtained in the IRLS, the Hₙ₊₁ is the homography of the current iteration and Hₙ is the homography of the previous iteration. In one embodiment, the procedure determines the stopping condition based on a difference measure between Hₙ₊₁ and Hₙ.

Let X=[u v 1]^{T} be the coordinates of an image point that gets most affected by the two homographies. Let Xₙ₊₁ and Xₙ be the transformed coordinates of point X in the image plane:

$${X}_{n + 1} = {[ {u}_{n + 1} {v}_{n + 1} 1 ]}^{T} {X}_{n} = {[ {u}_{n} {v}_{n} 1 ]}^{T} \qquad ( 3 )$$

Since Xₙ₊₁ and Xₙ are the transformed images of X at the current and previous iterations, respectively, we have:

$${X}_{n + 1} = {H}_{n + 1} X and {X}_{n} = {H}_{n} X \qquad ( 4 )$$

Define the tolerance or deviation between two consecutive iterations as:

$$J = {( {u}_{n + 1} - {u}_{n} )}^{2} + {( {v}_{n + 1} - {v}_{n} )}^{2} \qquad ( 5 )$$

J is a measure of difference between the two homographies Hₙ₊₁ and Hₙ. J can be written in terms of Xₙ₊₁ and Xₙ as follows:

$$J = {( {X}_{n + 1} - {X}_{n} )}^{T} ( {X}_{n + 1} - {X}_{n} ) \qquad ( 6 )$$

Substitute equation (4) into equation (6):

$$J = {( {H}_{n + 1} X - {H}_{n} X )}^{T} ( {H}_{n + 1} X - {H}_{n} X ) \qquad ( 7 )$$

$$J = {{X}^{T} ( {H}_{n + 1} - {H}_{n} )}^{T} ( {H}_{n + 1} - {H}_{n} ) X \qquad ( 8 )$$

Define H_{d} as the difference of homography matrices:

$${H}_{d} = {( {H}_{n + 1} - {H}_{n} )}^{T} ( {H}_{n + 1} - {H}_{n} ) \qquad ( 9 )$$

The difference measure J becomes:

$$J = {X}^{T} {H}_{d} X \qquad ( 10 )$$

Since J represents the difference between two consecutive homographies, it provides a stopping condition in which the homography in the current iteration does not differ much from the previous iteration. This condition suggests the iterative procedure has converged. Accordingly, the stopping condition is that J is less than a predetermined threshold T. Since J is a function which may have many values, this stopping condition is stated that the maximum value of J is less than the threshold T. The threshold T may be determined in advance based on test data or simulation results. It may be expressed as a constant value (e.g., 0.01) or as a percentage of a function of the magnitude of Xₙ₊₁ or Xₙ (e.g., 0.1%-2% of Xₙ₊₁ or Xₙ). In some embodiments, it may be set adaptively as a function of how fast or how slow the procedure is iterated.

The problem then can be formulated as an optimization problem to find the maximum value of J over the coordinates of X subject to the boundary conditions of the coordinates: 0≤u<W and 0≤v<L, where W and L are the width and height of the image, respectively.

$$arg {max}_{X} J = {X}^{T} {H}_{d} X = [ u v 1 ] {H}_{d} [ \begin{matrix}u \\ v \\ 1\end{matrix} ] \qquad ( 11 )$$

Note that H_{d} matrix is of quadratic form A^{T}A and is therefore positive semi definite. Therefore:

$$J = {X}^{T} {H}_{d} X \geq 0 \qquad ( 12 )$$

Accordingly, the minimum value of J is 0 and the maximum value would be at the constraints of the curve surface representing J.

FIG. 3 is a diagram illustrating a typical quadric surface 300 representing the difference measure between two consecutive iterations according to an embodiment. The quadric surface 300 includes a curve surface 310 and a cross section 350.

The curve surface shows a quadric surface 315 J(u, v) plotted in the coordinates (u, v). The curve surface is constrained at the boundaries by four boundary planes shown in dotted lines. Four coordinates for the boundary points are A (0,0), B(W, 0), C(W,L), and D (0,L). The minimum value is zero, shown as the bottom surface bounded by the four corner points A, B, C, and D. The projections of the parabolas on the bottom surface are ellipses as shown in ellipse 317. Since the curves are parabolas, their largest values are the intersections of the curves with the boundary planes at the four corner points A, B, C, and D. These intersections are P, Q, R, and S.

Therefore, the maximum value of J is the maximum value of J(u,v) at these corner coordinates of A, B, C, and D:

$${J}_{max} = max \{ J ( 0 , 0 ) , J ( W , 0 ) , J ( 0 , L ) J ( W , L ) \} \qquad ( 13 )$$

This maximum value Jₘₐₓ will then be compared with the threshold T. If it is less than T, then the iterative procedure is stopped.

$${J}_{max} < T \qquad ( 14 )$$

The threshold T is determined as discussed above. The cross section 350 shows the projections of the quadric surfaces on the bottom surface, These projections form ellipses like the ellipse 317.

FIG. 4 is a flowchart illustrating a process 400 of an efficient technique for homography estimation according to an embodiment.

Upon START, the process 400 extracts a first set of features from a first image and a second set of features from a second image (Block 410), The features may represent characteristic of the object or the scene in the images. Examples of the features are edge points, corner points. Next, the process 400 matches the first set to the second set to generate matched pairs of features (Block 420). This step is to determine the correspondence between the two sets of features. The matching or correspondence may be determined by correlation, local similarities, or RANSAC methods. Once the corresponding pairs are obtained, their coordinates are used in subsequent stages.

Then, the process 400 estimates parameters of a transformation that transforms the first set to the second set based on the matched pairs (Block 430). The estimation is carried out using an iterative procedure that generates a difference measure between a previous homography H₁ in a previous iteration n and a current homography Hₙ₊₁ in a current iteration n+1. The difference measure is calculated based on how each of the previous and current homomorphies transforms planar image coordinates of an image point. In one embodiment, the iterative procedure is an iterative re-weighted least squares (IRLS) procedure. The difference measure corresponds to a quadric surface that has a maximum value and the iterative procedure is terminated when the maximum value is less than a predetermined threshold. In one embodiment, the maximum value corresponds to a largest value of four corners of intersections between the quadric surface and four boundary planes of a coordinate system. The process 400 is then terminated.

FIG. 5 is a flowchart illustrating the process 430 shown in FIG. 4 for an iterative procedure for homography estimation according to an embodiment. The process 430 includes some operations or operator as follows: diag( ) creates a diagonal matrix from a column vector, mat( ) creates a 3×3 homography matrix from ab 8×1 vector, last element set to 1.0, δ=small value to avoid divide-by-zero error, N is the total number of feature points, Kₘₐₓ is the maximum number of IRLS iterations, W is the width of the image, L is the length of the image, A is a 2N×8 matrix, b is an 8×1 vector, P is a 2N×2N diagonal weight matrix, h is an 8×1 vector storing homography estimated parameters.

Upon START, the process 430 performs initialization of various parameters (Block 510). This includes setting δ to a small value, P=identity matrix, b, and hₙ₊₁=(A^{T} P A)⁻¹ (A^{T} P A), and the iteration index j=0. Then, the process 430 updates the hₙ to hₙ₊₁ (hₙ=hₙ₊₁) to prepare for the next iteration if the iteration is not stopped (Block 520).

Next, the process 430 performs the calculations to obtain the difference measure J (Block 530). This includes safeguards to ensure numerical stability. The operations include the following:

$$r = \vert b - Ah \vert \qquad ( 15 a )$$

$${P = diag ( max \{ r , δ ]}^{- 1} ) \qquad ( 15 b )$$

$${h}_{n + 1} = {( {A}^{T} PA )}^{- 1} ( {A}^{T} PA ) \qquad ( 15 c )$$

$${H}_{n + 1} = mat ( {h}_{n + 1} ) \qquad ( 15 d )$$

$${H}_{n} = mat ( {h}_{n} ) \qquad ( 15 e )$$

$${H}_{d} = {( {H}_{n + 1} - {H}_{n} )}^{T} ( {H}_{n + 1} - {H}_{n} ) \qquad ( 15 f )$$

Then, the process 430 determines the difference measure J:

$$J = {X}^{T} {H}_{d} X \qquad ( 16 )$$

The maximum value of J is determined by determining the values at the four corners (Block 550):

$$E = [ 001 ] {{H}_{d} [ 001 ]}^{T} \qquad ( 17 a )$$

$$Q = [ W 01 ] {{H}_{d} [ W 01 ]}^{T} \qquad ( 17 b )$$

$$R = [ 0 L 1 ] {{H}_{d} [ 0 L 1 ]}^{T} \qquad ( 17 c )$$

$$S = [ W L 1 ] {{H}_{d} [ W L 1 ]}^{T} \qquad ( 17 d )$$

$${J}_{max} = max \{ P , Q , R , S \} \qquad ( 17 e )$$

Then, the process 430 determines if Jₘₐₓ is less than a threshold T (Block 560). If so (YES at block 560), the final homography H_{final} is the current homography Hₙ₊₁ (Block 570) and the process 430 is then terminated. Otherwise (NO at block 560), the process 430 determines if the maximum iteration value Kₘₐₓ is reached. If so (YES at block 580), the process 430 goes to block 570, or to perform other suitable alerts. If not (NO at block 580), the process 430 increments the index j (Block 590) and returns to block 520.

The flowchart in FIG. 5 serves for illustration only. Variations may be made as suitable. At the end, the parameters of homography are obtained and may be used for subsequent stages.

FIG. 6 is a diagram illustrating a computing or processing system 600 according to an embodiment. The computing system 600 may be a system in which the image analyzer 180 may be deployed. It may supplement or replace any one or more of the blocks shown in FIG. 1. It includes a central processing unit (CPU) or a processor 610, a bus 620, and a platform controller hub (PCH) 630. The PCH 630 may include a graphic display controller (GDC) 640, a memory controller 650, and an input/output (I/O) controller 660. The processing system 600 may include more or less than the above components. In addition, a component may be integrated into another component. As shown in FIG. 6, all the controllers 640, 650, and 660 are integrated in the PCH 630. The integration may be partial and/or overlapped. For example, the GDC 640 may be integrated into the processor 610, the I/O controller 660 and the memory controller 650 may be integrated into one single controller, etc.

The processor 610 is a programmable device or a circuit that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 610 may have simultaneous multithreading feature to further exploit the parallelism due to multiple threads across the multiple cores. In addition, the processor 610 may have internal caches at multiple levels.

The bus 620 may be any suitable bus connecting the processor 610 to other devices, including the PCH 630. For example, the bus 620 may be a Direct Media Interface (DMI).

The PCH 630 in a highly integrated chipset that includes many functionalities to provide interface to several devices such as memory devices, input/output devices, storage devices, network devices, etc.

The I/O controller 660 controls input devices 668 (e.g., stylus, keyboard, and mouse, microphone, image sensor) and output devices (e.g., audio devices, speaker, scanner, printer), and a mass storage 664. The mass storage 664 may also include CD-ROM, hard disk, and SSDs. It also has a network interface card (NIC) 670 which provides an interface to a network and wireless medium 675.

The memory controller 650 controls memory devices such as a main memory 652 and a solid-state drive (SSD) 654. The main memory 652 includes random access memory (RAM) and/or the read-only memory (ROM) and other types of memory such as the cache memory. The main memory 652 may store instructions or programs, loaded from a mass storage device, that, when executed by the processor 610, cause the processor 610 to perform operations as described above. For example, the processor 610 may perform the functions of the feature extractor 120, the feature matcher 130, the parameter estimator 140, or the high-level interpreter 150 shown in FIG. 1. It may also store data used in the operations. The ROM may include instructions, programs, constants, or data that are maintained whether it is powered or not. The instructions or programs may correspond to the functionalities described above.

The GDC 640 controls a display device 645 and provides graphical operations. It may be integrated inside the processor 610. It typically has a graphical user interface (GUI) to allow interactions with a user like the user 185 in FIG. 1 who may send a command or activate a function.

Additional devices or bus interfaces may be available for interconnections and/or expansion. Some examples may include the Peripheral Component Interconnect Express (PCIe) bus, the Universal Serial Bus (USB), etc.

The technique to determine the stopping condition for the IRLS offers a number of advantages. First, it avoids sensitivity issue caused by small variations in one parameter. Second, it reflects more accurate the convergence behavior of the iterative procedure. Third, the techniques is simple to implement, requiring only searching for maximum value in four corners.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a feature extractor configured to extract a first set of features from a first image and a second set of features from a second image;
a feature matcher configured to match the first set of features to the second set of features to generate matched pairs of features;
a parameter estimator configured to estimate parameters of a transformation that transforms the first set of features to the second set of features based on the matched pairs using an iterative procedure that generates a difference measure between a previous homography in a previous iteration and a current homography in a current iteration, and
wherein the difference measure corresponds to a quadric surface that has a maximum value and the iterative procedure is terminated when the maximum value is less than a predetermined threshold.

2. The apparatus of claim 1 wherein the maximum value corresponds to a largest value of four corners of intersections between the quadric surface and four boundary planes of a coordinate system.

3. The apparatus of claim 1 wherein the iterative procedure is an iterative re-weighted least squares (IRLS) procedure.

4. The apparatus of claim 1 wherein the difference measure is a quadratic form of a homography matrix representative of a difference between the previous homography and the current homography.

5. The apparatus of claim 4 wherein the quadratic form includes the homographic matrix and a coordinate variable of an image point.

6. The apparatus of claim 4 wherein the difference measure is greater or equal to zero.

7. The apparatus of claim 1 wherein the parameter estimator creates non-homogeneous systems of equations using coordinates of the matched pairs.

8. The apparatus of claim 4 wherein the difference measure is calculated based on how each of the previous and current homographies transforms planar image coordinates of an image point.

9. The apparatus of claim 1 wherein the features in the first set of features and second set of features are points in at least one of the first image or the second image.

10. The apparatus of claim 7 wherein the first image and the second image are obtained from a first viewpoint and a second viewpoint different from the first viewpoint.

11. A method comprising:
extracting a first set of features from a first image and a second set of features from a second image;
matching the first set of features to the second set of features to generate matched pairs of features;
estimating parameters of a transformation that transforms the first set of features to the second set of features based on the matched pairs using an iterative procedure that generates a difference measure between a previous homography in a previous iteration and a current homography in a current iteration,
wherein the difference measure corresponds to a quadric surface that has a maximum value and the iterative procedure is terminated when the maximum value is less than a predetermined threshold.

12. The method of claim 11 wherein the maximum value corresponds to a largest value of four corners of intersections between the quadric surface and four boundary planes of a coordinate system.

13. The method of claim 11 wherein the iterative procedure is an iterative re-weighted least squares (IRLS) procedure.

14. The method of claim 11 wherein the difference measure is a quadratic form of a homography matrix representative of a difference between the previous homography and the current homography.

15. The method of claim 14 wherein the quadratic form includes the homographic matrix and a coordinate variable of an image point.

16. The method of claim 14 wherein the difference measure is greater or equal to zero.

17. The method of claim 11 wherein estimating comprises creating non-homogeneous systems of equations using coordinates of the matched pairs.

18. The method of claim 14 wherein the difference measure is calculated based on how each of the previous and current homomorphies transforms planar image coordinates of an image point.

19. The method of claim 11 wherein the features in the first set of features and second set of features are points in at least one of the first image or the second image.

20. A system comprising:
an image sensor configured to capture images including a first image and a second image of an object;
an image analyzer configured to analyze the images, the image analyzer comprising:
a feature extractor configured to extract a first set of features from the first image and a second set of features from the second image;
a feature matcher configured to match the first set of features to the second set of features to generate matched pairs of features;
a parameter estimator configured to estimate parameters of a transformation that transforms the first set of features to the second set of features based on the matched pairs using an iterative procedure that generates a difference measure between a previous homography in a previous iteration and a current homography in a current iteration,
wherein the difference measure corresponds to a quadric surface that has a maximum value and the iterative procedure is terminated when the maximum value is less than a predetermined threshold.
